(19) United States
(12) Patent Application Publication
(10) Pub. No.: US 2013/0043446 A1
(43) Pub. Date: Feb. 21, 2013

(54) CARGO GRABBING APPARATUS AND RELATED METHODS

(71) Applicant: ROBERT FIELDS, LONGVILLE, MN (US)

(72) Inventor: ROBERT FIELDS, LONGVILLE, MN (US)

(73) Assignee: EFAB LLC, LONGVILLE, MN (US)

(21) Appl. No.: 13/210,316

(22) Filed: Aug. 15, 2011

(51) Int. Cl. B25J 1/00

(52) U.S. Cl. 254/133 R

(57) ABSTRACT

A cargo grabbing apparatus is disclosed herein. In various aspects, the cargo grabbing apparatus includes a handle having a handle end and an opposite handle end, and a bar connected at a right angle to the handle proximate the handle end. In various aspects, a tube is disposed upon portions of the bar and disposed upon portions of the handle generally proximate the handle end, with the portions of the tube disposed upon the bar generally aligned longitudinally the bar and with the portions of the tube generally aligned longitudinally with the handle. A cord may be slideably received within the tube, the cord end and the opposing cord end of the cord manipulable by the user for placement about portions of cargo, in various aspects. This Abstract is presented to meet requirements of 37 C.F.R. §1.72(b) only. This Abstract is not intended to identify key elements of the apparatus and methods disclosed herein or to delineate the scope thereof.

### BACKGROUND OF THE INVENTION

1. Field

The present disclosure relates to hand tools and, more particularly, to hand tools for the manipulation of cargo within vehicles.

2. Background

Cargo may be emplaced on various cargo decks such as the bed of a pickup truck, the bed of a trailer, the cargo hold of an aircraft, the cargo compartments of cars, vans, or SUV's, or in other locations. The cargo may be positioned on the cargo deck where it is difficult to access for offloading, for example. The cargo deck itself may be difficult to access. Furthermore, cargo may shift during transport so that the cargo becomes even more difficult to access. Containers may fail so that the cargo is scattered about. The cargo itself may be sized and shaped such that manipulation of the cargo is difficult. The cargo may be of varying composition, for example, a cardboard box, paper sack, cloth sack, metal container, wooden box, loose parts and pieces, and so forth, which may be difficult to move or grasp. The cargo may be, for example, sacks or other amorphous shape object(s) that may be difficult to grasp and to move. The cargo may need to be up-righted, collected, or otherwise manipulated.

For example, consider a bed of a pickup truck as a cargo deck. Cargo may be positioned in the center of the bed of the pickup truck, where it may be difficult to reach. The bed of the pickup truck may be difficult to reach for a person standing upon the ground because of height of the bed with respect to the ground and because of the height of the sidewalls of the bed above the bed. In addition, the bed of the pickup truck may be enclosed by a topper, which may inhibit access to the bed. The cargo may shift forward toward the cab of the pickup truck during transport, which may make it even more difficult to access.

Accordingly, there is a need for improved cargo grabbing apparatus as well as related methods for accessing cargo on a cargo deck.

### BRIEF SUMMARY OF THE INVENTION

These and other needs and disadvantages may be overcome by the apparatus and related methods disclosed herein. Additional improvements and advantages may be recognized by those of ordinary skill in the art upon study of the present disclosure. A cargo grabbing apparatus is disclosed herein. In various aspects, the cargo grabbing apparatus includes a handle having a handle end and an opposite handle end, and a bar connected at a right angle to the handle proximate the handle end. In various aspects, a tube is disposed upon portions of the bar and disposed upon portions of the handle generally proximate the handle end, with the portions of the tube disposed upon the bar generally aligned longitudinally with respect to the bar and with the portions of the tube generally aligned longitudinally with the handle. A cord may be slidably received within the tube, the cord end and the opposing cord end of the cord manipulable by the user for placement about portions of cargo, in various aspects.

This summary is presented to provide a basic understanding of some aspects of the apparatus and methods disclosed herein as a prelude to the detailed description that follows below. Accordingly, this summary is not intended to identify key elements of the apparatus and methods disclosed herein or to delineate the scope thereof.

### BRIEF DESCRIPTION OF THE DRAWINGS

FIG. 1 illustrates by perspective view portions of an exemplary implementation of a cargo grabbing apparatus positioned about cargo on a cargo deck;

FIG. 2 illustrates by top view the exemplary implementation of the cargo grabbing apparatus of FIG. 1;

FIG. 3A illustrates by top view portions of the exemplary implementation of the cargo grabbing apparatus of FIG. 1;

FIG. 3B illustrates by cut-away view in correspondence to FIG. 3A portions the exemplary implementation of the cargo grabbing apparatus of FIG. 1;

FIG. 4 illustrates by top view the exemplary implementation of the cargo grabbing apparatus of FIG. 1 positioned about cargo;

FIG. 5 illustrates a view of the exemplary implementation of the cargo grabbing apparatus of FIG. 1 secured by a mount; and

FIG. 6 illustrates by perspective view portions of an exemplary implementation of a cargo grabbing apparatus.

The Figures are exemplary only, and the implementations illustrated therein are selected to facilitate explanation. The number, position, relationship and dimensions of the elements shown in the Figures to form the various implementations described herein, as well as dimensions and dimensional proportions to conform to specific force, weight, strength, flow and similar requirements are explained herein or are understandable to a person of ordinary skill in the art upon study of this disclosure. Where used in the various Figures, the same numerals designate the same or similar elements. Furthermore, when the terms “top,” “bottom,” “right,” “left,” “forward,” “rear,” “first,” “second,” “inside,” “outside,” and similar terms are used, the terms should be understood in reference to the orientation of the implementations shown in the drawings and are utilized to facilitate description thereof.

### DETAILED DESCRIPTION OF THE INVENTION

A cargo grabbing apparatus and related methods are disclosed herein. In various aspects, the cargo grabbing apparatus includes a handle with an end. A bar may be attached to the handle generally proximate the end, and the bar may be set generally at a right angle with respect to the handle. A cord is slidably received along portions of the bar and along portions of the handle, in various aspects, such that a cord end of the cord or both the cord end and an opposing cord end of the cord may be manipulated by the user. In various aspects, a tube may be located about portions of the bar and the tube may be located about portions of the handle generally proximate the end with portions of the tube located about the member generally aligned with the bar and with the portions of the tube located about the handle generally aligned with the handle. In such aspects, the cord may be slidably received within the tube. Methods of use of the cargo grabbing apparatus may include the steps of positioning the cord about portions of the cargo, positioning the bar about portions of the cargo, and dragging, pushing, or otherwise directing the cargo about a cargo deck using the bar, the cord, the handle, or various combinations of the bar, the cord, and the handle.

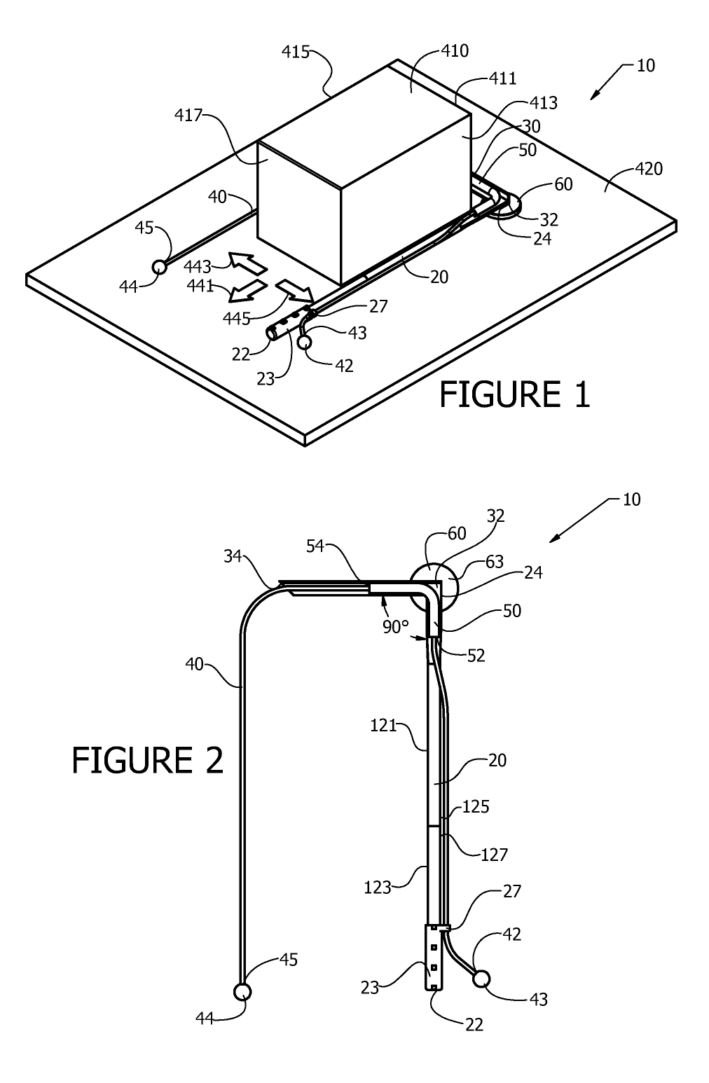

FIG. 1 illustrates an implementation of cargo grabbing apparatus 10. As illustrated in FIG. 1, cargo grabbing apparatus 10 includes handle 20 with bar 30 secured thereto and cord 40 slidably received about handle 20 and bar 30. Handle 20 and bar 30 may be formed of metal such as steel or aluminum, various plastics, combinations of metal and plastic, and so forth, in various implementations. Cord 40 may be a rope, cord, line, string, wire, cable, chain, or suchlike or combination thereof, and may be formed of various natural fibers, synthetic fibers, metals, plastics, or combinations thereof, in various implementations.

Handle 20, as illustrated in FIG. 1, defines end 24 and opposite end 22. Handle 20 includes grippable portion 23 located proximate opposite end 22, in this implementation. Grippable portion 23, as illustrated, is formed such that grippable portion 23 may be gripped by a hand of a user. Grippable portion 23 may include indentations that generally conform to the fingers of the user that enhance the ability of the user to grip handle 20. Grippable portion 23 may be roughened to facilitate gripping, and so forth. For example, grippable portions 23 may be formed into the handle 20 in some implementations, or, in other implementations, grippable portion 23 may be attached to handle 20. grippable portion 23 may be, for example, a plastic sleeve that fits securely over handle 20 that is configured to be gripped by a hand. The handle 20 may be configured in various other ways to include grippable portions 23 in various other implementations. The grippable portion 23 may be omitted in some implementations.

Bar end 32 of bar 30 is fixed to end 24 of handle 20 such that bar 30 generally forms about a 90° angle (see FIG. 2) with respect to handle 20. Bar 30 may form other angles, which may be either fixed or adjustable, with respect to handle 20, in other implementations. Bar 30 may be welded or otherwise affixed to handle 20 such that bar 30 remains at a fixed angle with respect to handle 20, in some implementations. In other implementations, handle 20 and bar 30 may be a unitary structure such that, for example, bar 30 and handle 20 are cast as a unitary piece or are formed by bending a unitary piece of material. In other implementations, bar 30 may be secured to handle 20 so that bar 30 is rotatably positionable with respect to handle 20, and the bar may be rotatably positionable between an extended position (as illustrated in FIGS. 1 and 2) and a collapsed position (not shown). In such implementations, for example, bar 30 may be held in locked extended position at an angle of about 90° with respect to handle 20 as the gripping apparatus 10 is employed. The bar 30 may then be released from the locked position, rotated into a collapsed position wherein the bar is collapsed to lie lengthwise against the handle (0° angle), and then locked into the collapsed position to facilitate transport or storage of the gripping apparatus 10.

Cord 40, as illustrated in FIG. 1, passes between cord end 42 and cord end 44 along portions of handle 20 and along portions of bar 30. Portions of bar 30 and portions of handle 20 may slidably receive cord 30 in various ways either externally, internally, or both externally and internally, and various structures may be provided about bar 30 and handle 20 to receive cord 30.

As illustrated in FIG. 1, cord end 42 includes cord stop 43 located thereabout, and cord end 44 includes cord stop 45 located thereabout. Cord stops 43, 45 may be, for example, a knot formed at ends 42, 44, respectively, of cord 40, or may be pieces of wood, metal, plastic, or combinations thereof secured about ends 42, 44 of cord 40. As illustrated in FIG. 1, cord stop 45 allows the user to grasp cord 40 proximate cord end 44 in order to manipulate cord 40. Cord 40, in this implementation, passes through eyelet 27 that is configured in handle 20 generally proximate end 22. Cord stop 43, in this implementation, prevents cord end 42 from passing through eyelet 27 and allows the user to grasp cord 40 proximate cord end 44 in order to manipulate cord 40. The user may slidably position cord 40 including cord ends 42, 44 with respect to handle 20 and bar 30 by pulling upon cord ends 42, 44, in various implementations.

As illustrated in FIG. 1, cargo 410 is placed upon cargo deck 420. Although cargo 410 is illustrated as a box having a generally rectangular cubical shape in FIG. 1, in various implementations, cargo 410 may be, for example, a box, bag, container, package, suitcase, toolbox, or other object, and may be of regular shape, irregular shape, or amorphous shape.

Cargo deck 420 may be, for example, the bed of a pickup truck, the floor of a van or truck, the cargo hold of an aircraft, the floor of a cargo compartment of an SUV, a floor of an automobile trunk, or suchlike upon which cargo 410 may be placed. As illustrated in FIG. 1, cargo grabbing apparatus 10 is positioned such that bar 30 is placed against surface 411 of cargo 410 that is generally opposite to the direction that cargo 410 is to be moved. Cord 40 may be manipulated in various ways including by cord end 44, cord end 42, or both cord ends 42, 44 and by manipulation of handle 20 and bar 30 to place cord 42 against portions of cargo 410 generally opposite to the direction that cargo 410 is to be moved. As illustrated in FIG. 1, cord 42 is placed against portions of surfaces 411, 415. With the cord placed against, for example, portions of surfaces 411, 415 and with bar 30 placed against portions of surface 411, the user may then, for example, pull on cord end 44 of cord 40 and on grippable portion 23 to pull cargo 410 about cargo deck 420, as indicated by the arrow in FIG. 1. The cargo 410 may be thus pulled generally toward the user, in various implementations. As the cargo 410 is pulled about cargo deck 420 in this example, both bar 30 and cord 40 are engaged with the cargo 410, as illustrated. The user may grasp the cord other than at cord end 44 and may grasp the handle 20 at any convenient point in order to manipulate cord 40, handle 20, bar 30 or in order to pull the cargo 410 about cargo deck 420.

As illustrated in FIG. 2, bar 30 extends from bar end 32, which is generally secured to handle 20, to bar end 34. Bar end 34, in this implementation, is beveled to a point, which may facilitate the use of bar 30 portion of cargo grabbing apparatus 10 in manipulating cargo such as cargo 410. Bar end 34 may be flat or may have other configurations in other implementations.

As illustrated in FIG. 2, cargo grabbing apparatus 10 includes tube 50 portions of which pass along portions of handle 20 generally proximate end 24. The portion of tube 50 that passes along handle 20 is generally aligned with handle 20 such that an axis of that portion of tube 50 generally parallels the length of handle 20, as illustrated. In this implementation, tube 50 curves about a 90° angle such that tube 50 transitions between placement along portions of handle 20 and portions of bar 30. Portions of tube 50 pass along portions of bar 30 generally proximate bar end 32 of bar 30. The portion of tube 50 that passes along bar 30 is generally aligned with bar 30 such that the axis of that portion of tube 50 generally parallels the length of bar 30. Tube 50 defines tube ends 52, 54, as illustrated.

In the implementation illustrated in FIG. 2, cord end 43 is located generally proximate handle end 22 of handle 20. Cord 40 passes through eye 27, which is formed as a hole in handle 27 generally proximate handle end 22, in this implementation. Eye 27 may hold cord 40 including cord end 42 generally proximate handle end 22 of handle 20 to present cord 40 to the user when the user grasps cargo grabbing apparatus 10 by handle 20. The user may grasp cord 40 generally proximate handle end 22 of handle 20, and the user may manipulate cord 40 generally proximate handle end 22 of handle 20. In other implementations, eye 27 may be formed as various eyes, holes, tubes, and other fittings through which cord 40 may pass. Cord 40, as illustrated, lies along handle 20 passing from eye 27 through tube 50 between tube end 52 and tube end 54. Eye 27 in combination with tube 50 may generally retain cord 40 proximate handle 20 generally along the length of handle 20, which may prevent these portions of cord 40 from being entangled either with itself or with other objects particularly as cargo grabbing apparatus 10 is employed. Cord 40 passes forth from tube end 54 of tube 50 generally along bar 30. Tube 30 may turn the orientation of cord 40 so that portions of cord 40 may be aligned with bar 30, as illustrated.

Cord 40, in this implementation, is slidably received in eye 27 and in tube 50, so that the user may position the cord 40 with respect to eye 27 and tube 50, for example, by pulling upon cord ends 42, 44. Accordingly, by pulling upon cord end 42 of cord 40, the user may draw cord 40 through eye 27 and tube 50 to retract cord 40, which shortens the length of cord 40 lying between tube end 54 of tube 50 and cord end 44. By pulling upon cord end 44 of cord 40, the user may draw cord 40 through eye 27 and tube 50 to extend cord 40, thereby lengthening the length of cord 40 lying between tube end 54 of tube 50 an cord end 44. In other implementations (not shown) tube 40 may be formed as a plurality of tubes, one or more eyes, or suchlike. In other implementations (not shown), cord 40 may pass internally within at least portions of handle 20 or bar 30 or both handle 20 or bar 30. In such implementations, tube 50, eye 27, or both tube 50 and eye 27 ay be omitted. Cord 40 may be fixedly connected to handle 20 or to bar 30 or to both handle 20 and bar 30, in other implementations.

Handle 20 may be extendable and collapsible, in various implementations, by, for example, being constructed as a telescoping unit. For example, as illustrated in FIG. 2, handle 20 is formed with telescoping sections 121, 123 that are slidably positionable between an extended handle position and a collapsed handle position with respect to one another. In the extended position, illustrated in FIG. 2, telescoping sections 121, 123 are slid apart from one another such that end 125 of telescoping section 121 is positioned proximate handle end 127 of telescoping section 123. In the collapsed position (see FIG. 5) telescoping section 121 is slidably received within telescoping section 123 such that end 125 of telescoping section lies generally proximate end 22 of handle 20 within telescoping section 123. Other implementations may include any number of telescoping sections.

Telescoping sections 121, 123 may be formed such that application of a twist to handle 20 may unlock the telescoping sections 121, 123 with respect to one another to allow the telescoping sections 121, 123 to slide with respect to one another so that the handle may be extended or collapsed. Application of a subsequent reverse twist to handle 20, in such implementations, may lock the telescoping sections 121, 123 into position with respect to one another, for example, in order to lock the handle into an extended position or into the collapsed position. Handle 20 may be extendable and collapsible between the collapsed position and the extended position in other ways, in various implementations. Handle 20 may be positionable between a collapsed position, an extended position, and at positions intermediate of the collapsed position and the extended position, in various implementations.

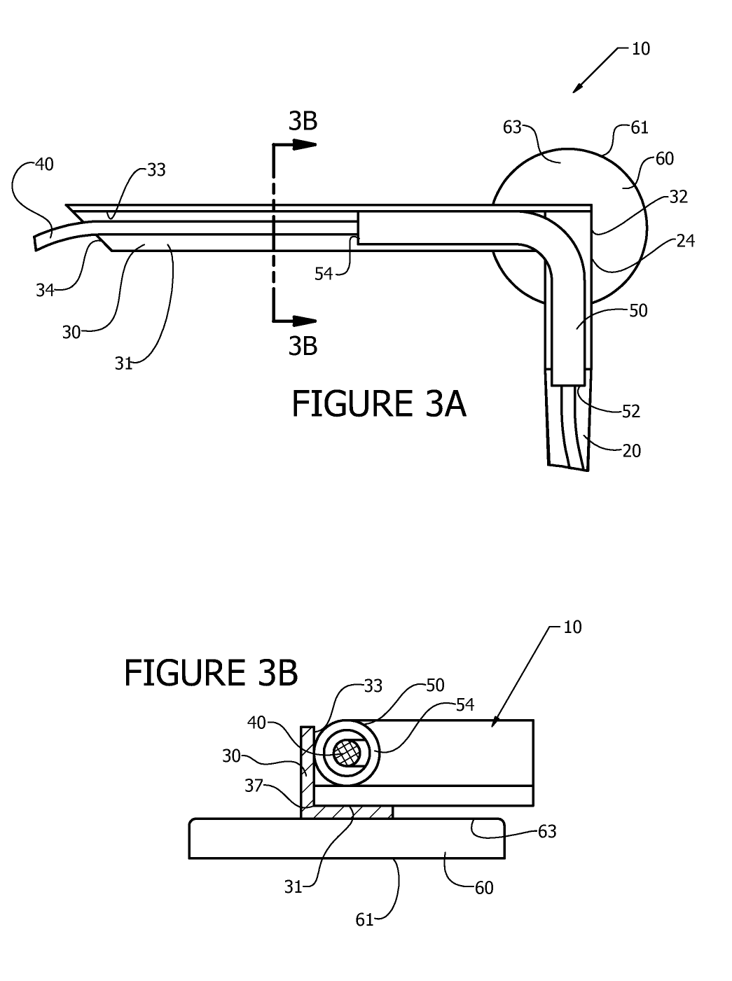

FIGS. 3A and 3B illustrates portions of cargo grabbing apparatus 10 including bar 30 and tube 50 along with portions of handle 20 and cord 40. As illustrated in FIGS. 3A and 3B, bar 30 is formed as an L-shaped member that defines surfaces 31, 33, although bar 30 may have other shapes in other implementations. As illustrated in FIG. 3A, tube 50 is positioned generally at the juncture of bar 30 with handle 20. Cord 40 passes through tube 50 so that tube 50 aligns cord 40 with handle 20 lengthwise along handle 20 and with bar lengthwise along bar 30, in this implementation. The portion of cord 40 that extends along bar 30 may be biased against surface 31, surface 33, or both surface 31 and surface 33 to allow manipulation of cord 40 by bar 30 portion of cargo grabbing apparatus 10. Bar 30 may be used by the user to manipulate cord 40 in order to place portions of cord 40 about cargo such as cargo 410 (see FIG. 1).

FIG. 3B illustrates a cross-sectional view of the bar looking toward tube end 54 of tube 50. As illustrated in FIG. 3B, cord 40 is slidably received within tube 50, as the internal diameter of tube 50 is greater than the external diameter of cord 40. The intersection of surface 31 with surface 33 defines groove 37, as illustrated. Groove 37 may be used to catch portions of cord 40 to manipulate cord 40 in order to, for example, place portions of cord 40 about cargo such as cargo 410. Surfaces 31, 33, groove 37, or combinations thereof may secure portions of cord 40 to bar 30 by biasing those portions of cord 40 against surfaces 31, 33, groove 37, or combinations thereof as the user pulls the cargo, such as cargo 410, about the cargo deck, such as cargo deck 420, using cord 40 in combination with handle 20.

With reference to FIGS. 3A and 3B, cargo grabbing apparatus 10 includes magnet 60, which is formed of a magnetic material that may be ferrous, non-ferrous, or combinations thereof. Magnet 60 forms magnet surfaces 61, 63, as illustrated, and magnet 60 is secured at the juncture of bar 30 with handle 20 with magnet surface 63 oriented toward handle 20 and bar 30. Magnet surface 61 is generally planar, as illustrated, and oriented away from handle 20 and bar 30. Magnet 60 may be used to capture magnetically attractable cargo that, for example, has a steel component, and such cargo may be magnetically attached to surface 61 of magnet 60. Magnet 60 may be attached to magnetically attractable cargo so that the magnetically attractable cargo may be manipulated using cargo grabbing apparatus 10. Magnet 60 is illustrated as being circular in shape with planar surface 61, but magnet 60 including surface 61 may have other shapes in other implementations.

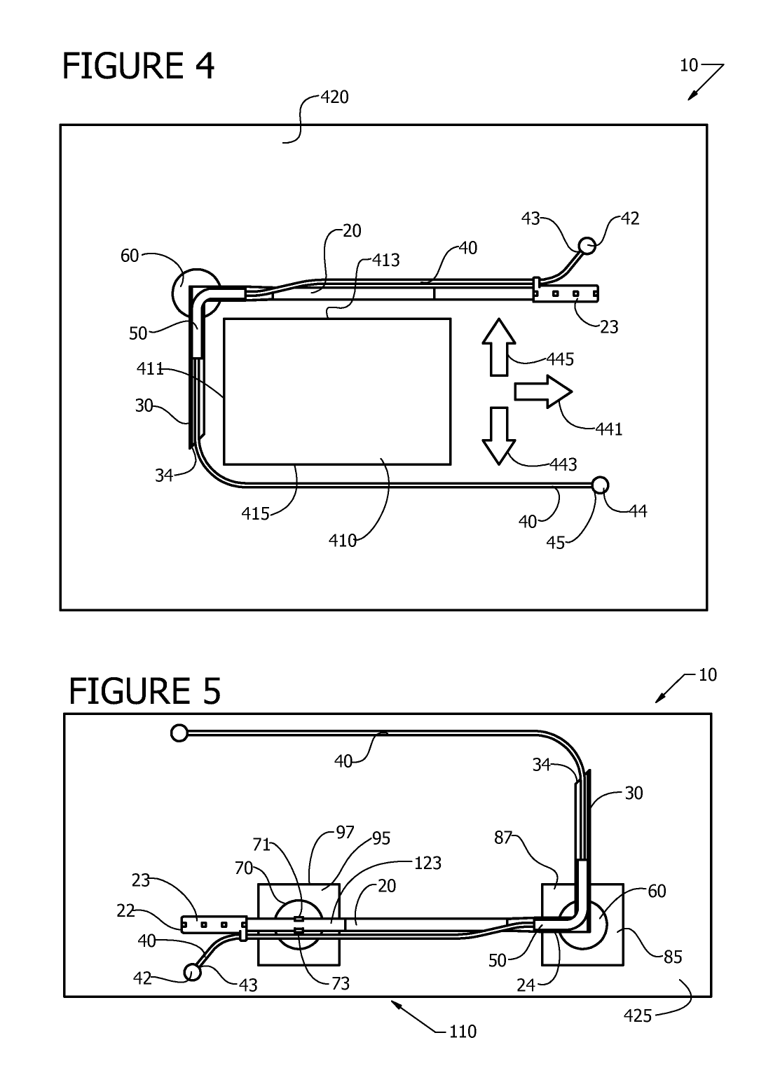

FIG. 4 illustrates cargo grabbing apparatus 10 as cargo grabbing apparatus is used to manipulate cargo 410. As illustrated in FIG. 4, cargo grabbing apparatus 10 is positioned so that portions of bar 30 are placed about surface 411 of cargo 410. Cord 40 may be manipulated so that, as illustrated, portions of cord 40 are proximate surface 411 of cargo 410 and portions of cod 40 are proximate surface 415 of cargo 410. Portions of handle 20 are proximate surface 413 of cargo 410, as illustrated. With handle 20, bar 30, and cord 40 positioned as illustrated in FIG. 4, the user may move the cargo in the directions 441, 443, 445 by pushing against surfaces 411, 413, 415 with gripping apparatus 10 by pulling portions of cord 40 and bar 30 against surface 411, portions of handle 20 against surface 413, and portions of cord 40 against surface 415, respectively. The user may grasp cord end 44 of cord 40 and grippable surface 23 of handle 20 to manipulate cord 40 and manipulate handle 20 with bar 30 attached thereto to pull portions of cord 40 and bar 30 against surface 411, portions of handle 20 against surface 413, and portions of cord 40 against surface 415. Accordingly, the user may position cargo 410 about cargo deck 420 by directing the cargo in directions 441, 443, 445, or combinations thereof by pulling portions of gripping apparatus 10 against portions of cargo 410.

FIG. 5 illustrates cargo grabbing apparatus 10 as secured for storage generally to surface 425 by mount 110. In various implementations, surface 425 may be a portion of the vehicle transporting cargo 410. Surface 425 may be adjacent cargo deck 420 such as, for example, the side of the bed of a pickup truck, the lid of an automobile trunk, the door to a cargo compartment. Mount 110 may be attached to surface 425 generally at a location such that, when the cargo grabbing apparatus 10 is attached to mount 110, the user may easily reach the cargo grabbing apparatus 10. In various implementations, mount 110 may include holder 70, plate 85, and plate 95. As illustrated in FIG. 5, handle 20 is positioned in the collapsed position with telescoping section 121 (not visible) slidably received within telescoping section 123.

As illustrated in FIG. 5, magnet 60 is secured to surface 87 of plat 85. In implementations in which surface 425 is a non-magnetic material, plate 85 is formed of steel or other such magnetic material to provide surface 87 to which magnet 60, and, hence, cargo grabbing apparatus 10 may be magnetically secured. For example, a plastic (or other non-magnetic material) bed liner of the bed of a pickup truck or other vehicle may form surface 425. Plate 85 may then be attached to this plastic bed liner to provide surface to which magnet 60 may be magnetically attached. Plate 85 may be mounted to surface 425, for example, using various screws, bolts, adhesives, and so forth, in various implementations. In implementations wherein surface 425 is of a magnetic material, plate 85 may be omitted and magnet 60 may be attached magnetically directly to surface 425.

As illustrated in FIG. 5, clips 71, 73 of holder 70 capture handle 20 to secure handle 20 releasably to holder 70. Other mechanisms may be used to secure releasably handle 20 to holder 70, in other implementations. Holder 70, in this implementation, includes a magnet so that holder 70 may be magnetically attached to a magnetic material. Holder 70, in this implementation, is magnetically attached to plate 95, and plate 95, in turn, is secured to surface 425. Plate 95, in this implementation, is formed of a magnetic material so that holder 70 may be magnetically attached to plate 95. Plate 95 may be mounted to surface 425, for example, using screws, bolts, adhesive, or other fasteners, in various implementations. Plate 95 may be attached to surface 425 to provide a magnetic material to which holder 70 may be magnetically attached in implementations in which surface 425 is non-magnetic. In implementations in which surface 425 is magnetic, holder 70 may be magnetically attached to surface 425 and plate 95 may be omitted. In still other implementations, holder 70 may be mounted directly to surface 425 non-magnetically using, for example, various screws, bolts, adhesives, or other fasteners.

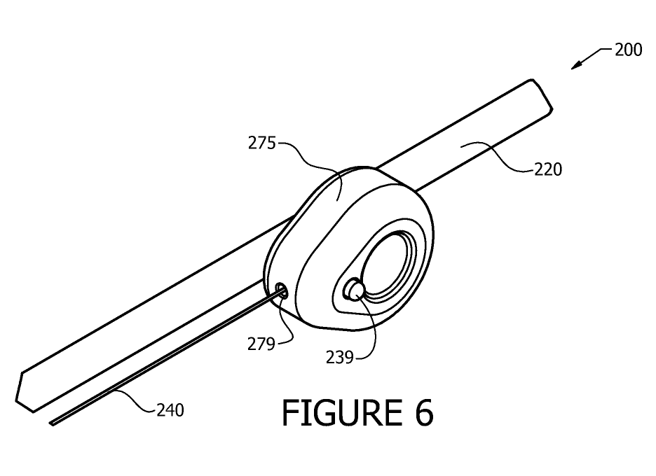

FIG. 6 illustrates handle 220 of cargo grabbing apparatus 200 with reel 275 secured to handle 220. As illustrated in FIG. 6, cord 240 is windingly received by reel 275. The user may spool cord 240 from reel 275 by hand to extend the length of cord 240. As cord 240 is stripped from reel 275, a spring (not shown) within reel 275 is tensioned, in this implementation. The user may push button 239 that cooperates with the spring to releases the spring thereby driving a winding mechanism (not shown) to wind cord 240 upon reel 275 in order to retract cord 240, in this implementation. Various other sources of power other than a spring may be provided to wind cord 240 upon reel 275 in other implementations. In some implementations, reel 275 may be hand cranked.

Reel, such as reel 275, as used herein, may further include, for example, a spool, a cleat, various keeps, or so forth, that may be provided about the handle, such as handle 20, 220 to spool cord such as cord 40, 240 off of as the cord is extended or to wind cord, thereupon as the cord is retracted, in various other implementations. The reel may be manual or at least partly automated in various implementations.

Operation of the cargo grabbing apparatus, such as cargo grabbing apparatus 10, 200, may include positioning portions of the bar, such as bar 30, about portions of the cargo, such as surface 411 of cargo 410. Operation of the cargo grabbing apparatus may include manipulating the cord, such as cord 40, 240, so that portions of the cord are proximate one or more surfaces of the cargo, such as surfaces 411 and 415 or cargo 410. Operation of the cargo grabbing apparatus may include positioning portions of the handle, such as handle 20, 220, proximate the cargo, such as proximate surface 413 of cargo 410. With the handle, the bar, and the cord positioned about the cargo, the user may move the cargo in various directions, such as directions 441, 443, 445, by applying forces to surfaces of the cargo by pushing or pulling portions of the cord, the bar 30, and the handle 20 against surface(s) of the cargo. The user may manipulate the cord by grabbing portions of the cord, such as cord end 44 of cord 40. The user may manipulate the handle and bar attached there to using the grippable surface, such as grippable surface 23. The user may manipulate the cord and the handle to position the cord, the bar, and the handle about the cargo, and to position the cargo about the cargo deck, such as cargo deck 420. Operations may include moving the cargo about the cargo deck in various directions or combinations of directions. The user may manipulate the cord, at least in part using the bar. For example, the user may place the cord about portions of the cargo using the bar. The bar, in various implementations, may be configured to capture at least portions of the cord to facilitate user manipulation of the cord using the bar. The user may slide the cord, in various implementations, to alter the length of the cord between the bar end of the bar, such as bar end 34 of bar 30, by retracting the cord or extending the cord. Operations may include winding the cord onto or off of a reel, such as reel 275, in various implementations. In various implementations, the reel may automatically wind the cord. In various implementations, the user may wind the cord upon the reel by hand or may spool the cord from the reel by hand.

The foregoing discussion along with the Figures discloses and describes various exemplary implementations. These implementations are not meant to limit the scope of coverage, but, instead, to assist in understanding the context of the language used in this specification and in the claims. Upon study of this disclosure and the exemplary implementations herein, one of ordinary skill in the art may readily recognize that various changes, modifications and variations can be made thereto without departing from the spirit and scope of the inventions as defined in the following claims.

The invention claimed is:

1. A cargo grabbing apparatus, comprising
a handle having a handle end and an opposite handle end;
a bar connected to the handle at a right angle proximate the handle end;
a tube disposed upon portions of the bar and disposed upon portions of the handle generally proximate the handle end, with the portions of the tube disposed upon the bar generally aligned longitudinally the bar and with the portions of the tube generally aligned longitudinally with the handle; and
a cord slideably received within the tube, the cord end and the opposing cord end of the cord manipulable by the user for placement about portions of cargo.

2. The cargo grabbing apparatus, as in claim 1, further comprising:
a magnet disposed generally about the handle end of the handle.

3. The cargo grabbing apparatus, as in claim 1, wherein the bar is L-shaped.

4. The cargo grabbing apparatus, as in claim 1, wherein the handle is formed in telescoping sections such that the handle is extendable and collapsible.

5. The cargo grabbing apparatus, as in claim 1, wherein the cord end is slideably received by the handle proximate the opposite handle end.

6. The cargo grabbing apparatus, as in claim 1, further comprising:
a reel disposed about the handle to receive the cord thereupon.

7. The cargo grabbing apparatus, as in claim 1, further comprising:
a mount for securing the cargo grabbing apparatus to a vehicle.

8. The cargo grabbing apparatus, as in claim 7, wherein the mount includes at least one plate formed of a magnetic material, the plate configured to be secured to a non-magnetic side of a cargo deck.

9. The cargo grabbing apparatus, as in claim 7, wherein the mount includes a magnetically securable holder.

10. A method of manipulating cargo using a cargo grabbing apparatus, comprising:
positioning portions of a bar of a cargo grabbing apparatus about portions of a cargo, the cargo grabbing apparatus comprising a handle, a bar and a cord with the bar secured to a handle end of the handle and the cord disposed about the handle and the bar;
manipulating the cord to position portions of the cord about the cargo; and
dragging the cargo across a cargo deck by pulling on the handle and the cord thereby pulling on the cargo with the cord and the bar in concert with one another.
